(19) United States
(12) Patent Application Publication
(10) Pub. No.: US 2014/0109884 A1
(43) Pub. Date: Apr. 24, 2014

(54) AUTOMOTIVE ENGINE COOLANT AND HEATING SYSTEM

(71) Applicants: Daniel E Hornback, Davisburg, MI (US); Kevin J Laboe, Birmingham, MI (US); Gregg T Black, Livonia, MI (US)

(72) Inventors: Daniel E Hornback, Davisburg, MI (US); Kevin J Laboe, Birmingham, MI (US); Gregg T Black, Livonia, MI (US)

(21) Appl. No.: 13/657,910

(22) Filed: Oct. 23, 2012

(51) Int. Cl. F02B 29/04; F02B 37/00

(52) U.S. Cl. 123/568.12; 60/599; 60/602; 60/605.2; 123/568.21

(57) ABSTRACT

Engine coolant heating systems and methods that improve waste heat recovery. The systems and methods include a piped connection between the outlet of an exhaust gas recirculation cooler and the main exhaust pipe leading to the vehicle's tailpipe. The systems and methods also include at least one additional valve in the exhaust stream for directing the flow of exhaust appropriately given specific driving conditions.

### FIELD

The present disclosure relates generally to internal combustion gas engines and more particularly to exhaust gas recirculation systems for such engines.

### BACKGROUND

Exhaust gas recirculation (EGR) is used in many internal combustion (IC) engines, and particularly gasoline and diesel engines. In an EGR system, a portion of an engine's exhaust gas is recirculated back to the engine cylinders. Therefore, at a time when a cylinder allows fuel, oxygen and other combustion products into the combustion chamber for ignition, vehicle exhaust is also allowed to enter the chamber.

The introduction of vehicle exhaust into the combustion chamber has a number of consequences. One consequence is that the introduced exhaust displaces the amount of combustible matter in the chamber. Because the exhaust gases have already combusted, the recirculated gases do not burn again when introduced to the chamber. This results in a chemical slowing and cooling of the combustion process by several hundred degrees Fahrenheit. Thus, combustion of material in the cylinder results in a same pressure being exerted against the cylinder piston as results from combustion without the recycled exhaust, but at a lower temperature. The lower temperature leads to a reduced formation rate for nitrous oxide emissions. Thus, the EGR technique results in less pollutants being emitted in an engine's exhaust.

Additionally, the introduction of recirculated exhaust gas into an engine cylinder allows for an increase in engine performance and fuel economy. As the combustion chamber temperature is reduced, the potential for harmful “engine knock” or engine detonation is also reduced. Engine detonation occurs when the fuel and air mixture in a cylinder ignite prematurely due to high pressure and heat. In engine detonation, instead of an associated spark plug controlling when a cylinder's fuel is ignited, the ignition occurs spontaneously, often causing damage to the cylinder. However, when the combustion chamber temperature is reduced due to EGR, the potential for engine detonation is also reduced. This allows vehicle manufacturers to program more aggressive (and hence, more efficient) timing routines into an associated spark timing program. Because of the aggressive timing routines, the vehicle's power control module (PCM) has a greater advance notice and thus more time to take measures to prevent engine detonation. The aggressive timing routines can also result in higher cylinder pressures leading to increased torque and power output for the vehicle. For these and additional reasons, high levels of EGR are especially useful when applied to turbocharged or supercharged engines.

FIG. 1 shows a conventional cooled EGR system 10. The system 10 comprises an intake manifold 12 connected to an engine block 14. Exhaust from the engine block 14 is passed through a catalytic converter 16, an EGR cooler 18 and an EGR valve 20, the opening and closing of which is controlled by an engine control unit 40 or other suitable controller. It should be appreciated that necessary piping/tubing and connections to components within the system 10 are illustrated as connection arrows for convenience purposes and are not numerically labeled in FIG. 1. In the conventional cooled EGR system 10, a portion of the exhaust gas (up to about 40%) from the engine block 14 is split off from the main exhaust piping and routed through the EGR cooler 18. The entire portion of the cooled exhaust gas that went through the cooler 18 is then routed back to the engine intake manifold 12 (via EGR valve 20) where it is mixed with fresh air and re-introduced into the combustion chamber of the engine block 14.

There is a large amount of heat energy contained in the exhaust gas due to its extremely high temperature and high flow rate during certain driving conditions. In a vehicle with non-cooled EGR, the heat energy in the exhaust is “wasted” out of the tailpipe. In the conventional EGR system 10 illustrated in FIG. 1, a portion of this exhaust heat is “recovered” (i.e., it is channeled into the coolant via the EGR cooler 18). Nonetheless, since only a small fraction (up to about 40%) of the exhaust can be sent back to the engine 14 for re-combustion, the majority of the exhaust gas and heat is still wasted out of the tailpipe. Accordingly, there is a need and desire for an improved vehicle exhaust/waste heat recovery system.

### SUMMARY

In one form, the present disclosure provides an engine coolant heating system for a vehicle. The system comprises an exhaust gas recirculation cooler having an input for receiving exhaust gas from an engine and an output for outputting cooled exhaust gas; an exhaust gas recirculation valve connected between an input of an intake manifold and the output of the exhaust gas recirculation cooler; and at least one additional valve connected at least between the input of the exhaust gas recirculation cooler, an output of the exhaust gas recirculation cooler and an exhaust output. The at least one additional valve is for configuring the system in a first configuration whereby a portion of the exhaust gas from the engine is passed through the cooler before a predetermined amount of cooled exhaust gas is passed through the exhaust gas recirculation valve to the intake manifold, and for configuring the system in a second configuration whereby substantially all of the exhaust gas from the engine is passed through the cooler before the predetermined amount of cooled exhaust gas is passed through the exhaust gas recirculation valve to the intake manifold.

The present disclosure also provides method of recirculating exhaust gas output from an engine. The method comprises configuring an exhaust gas recirculation valve and at least one additional valve into a first configuration whereby a portion of exhaust gas output from the engine is passed through an exhaust gas recirculation cooler before a predetermined amount of cooled exhaust gas is passed through the exhaust gas recirculation valve to an intake manifold; and configuring the exhaust gas recirculation valve and the at least one additional valve into a second configuration whereby substantially all of the exhaust gas output from the engine is passed through the cooler before the predetermined amount of cooled exhaust gas is passed through the exhaust gas recirculation valve to the intake manifold.

In one embodiment, the at least one additional valve is a single multi-position valve having a first position corresponding to the first configuration and a second position corresponding to the second configuration.

In another embodiment, the at least one additional valve comprises a first valve connected between the input of the cooler and the exhaust output; and a second valve connected between a connection of an output of the first valve and the exhaust output and a connection between the output of the cooler and an input of the exhaust gas recirculation valve. The first valve causes substantially all of the exhaust gas from the engine to be passed through the cooler in the second configuration. The second valve causes no cooled exhaust gas to pass to the exhaust output in the first configuration and a second predetermined portion of cooled exhaust gas to pass to the exhaust output in the second configuration.

In another embodiment, the predetermined amount of cooled exhaust gas is less than or equal to 40% of the cooled exhaust gas. In another embodiment, the portion of the exhaust gas is less than or equal to 40% of the exhaust gas.

Further areas of applicability of the present disclosure will become apparent from the detailed description provided hereinafter. It should be understood that the detailed description, including disclosed embodiments and drawings, are merely exemplary in nature intended for purposes of illustration only and are not intended to limit the scope of the invention, its application or use. Thus, variations that do not depart from the gist of the invention are intended to be within the scope of the invention.

### BRIEF DESCRIPTION OF THE DRAWINGS

FIG. 1 illustrates a conventional cooled EGR system.

FIGS. 2 and 3 illustrate an engine coolant heating system in accordance with a first disclosed embodiment.

FIGS. 4 and 5 illustrate an engine coolant heating system in accordance with a second disclosed embodiment.

FIG. 6 illustrates an engine coolant heating system in accordance with a third disclosed embodiment.

FIG. 7 illustrates an engine coolant heating system in accordance with a fourth disclosed embodiment.

### DETAILED DESCRIPTION

According to the principles disclosed herein, and as discussed below, engine coolant heating systems that improve waste heat recovery are disclosed and include a piped connection between the outlet of an EGR cooler and the main exhaust pipe leading to the vehicle's tailpipe. The systems also include a system of valves in the exhaust stream that direct the flow of exhaust appropriately given the specific driving conditions.

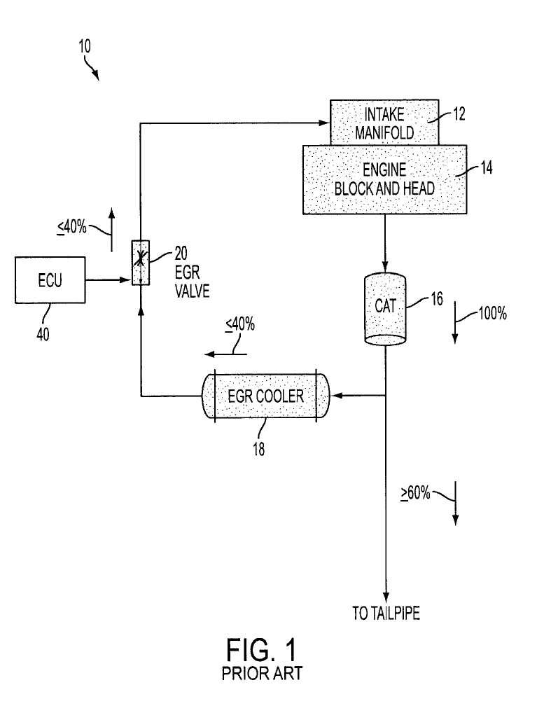

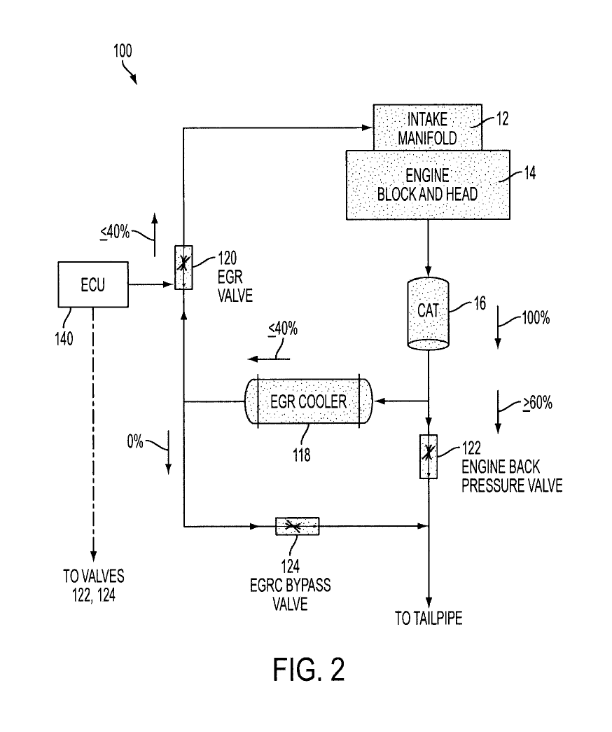

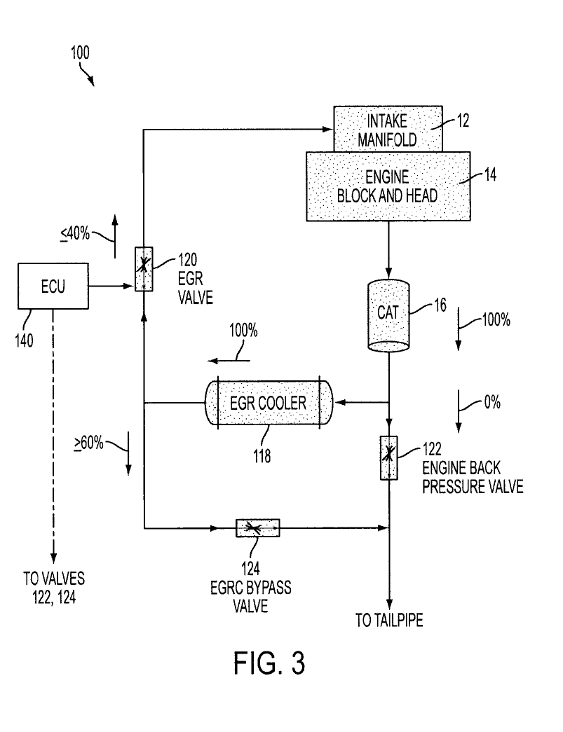

Referring to FIGS. 2 and 3, an engine coolant heating system 100 in accordance with a first disclosed embodiment is now described. As with the conventional system 10 illustrated in FIG. 1, system 100 includes an intake manifold 12, an engine block 14, and a catalytic converter 16. The illustrated system 100 also includes an EGR cooler 118, EGR valve 120, engine back pressure valve (EBPV) 122 and an EGRC bypass valve (EBV) 124. The engine back pressure valve 122 is connected between the exhaust piping to the tailpipe and a connection between the inlet of the cooler 118 and outlet of the catalytic converter 16. The EGR bypass valve 124 is connected between the exhaust piping to the tailpipe and a connection between the outlet of the cooler 118 and an inlet of the EGR valve 120. The opening and closing of the valves 120, 122 and 124 are controlled in the manner disclosed below by an engine control unit 140 or other suitable controller. It should be appreciated that necessary piping/tubing and connections to components within the system 100, as well as all other piping/tubing and connections for the additional systems discussed below, are illustrated as connection arrows for convenience purposes and are not numerically labeled.

FIG. 2 illustrates a first operating scenario for system 100. In the illustrated system 100, the EGR cooler 118 receives up to about 40% of the total exhaust flow from the engine at the engine's peak power condition. In this mode of operation, it is assumed that the coolant is already at the optimal operating temperature and there is no need for coolant heating. In this case, the engine back pressure valve 122 is open and the EGR bypass valve 124 is closed. The EGR valve 120 is set to a position that allows approximately 40% of the exhaust flow to go through the EGR cooler 118 and then back to then engine 14 (via manifold 12) for re-combustion. The at least 60% of the exhaust gas that is not re-circulated simply continues down the main exhaust pipe and out of the vehicle. In this mode of operation, the system 100 behaves like the conventional cooled EGR system 10 of FIG. 1.

Referring to FIG. 3, at engine cold start, there is a need to rapidly heat up the engine coolant to reach the optimal temperature for efficient engine and transmission operation. In almost all cases, the engine 14 operates at a low speed and load in the few minutes after cold start. The illustrated system 100 disclosed herein is designed to rapidly heat the coolant at cold start even with low engine speed and load. In this mode of operation, the engine back pressure valve 122 is closed, forcing up to 100% of the exhaust flow through the EGR cooler 118, along with its heat energy, which is then channeled into the coolant circuit. The “recovered” waste heat now contained in the coolant can be distributed among the other drivetrain fluids for quicker warm-up, and higher steady state temperatures. Downstream of the EGR cooler 118, the position of the EGR valve 120 is set to allow up to approximately 40% of the flow to return to the intake manifold 12. The EGR bypass valve 124 is set to provide an appropriate back pressure on the system 100 to force up to about 40% of the flow through the EGR valve 120 and back to the engine 14. The remainder of the flow passes through the engine back pressure valve 122, back to the main exhaust pipe, then out of the vehicle.

Thus, one advantage of the disclosed engine coolant heating system 100 is that the three illustrated valves 120, 122, 124 can be controlled such that during coolant warm-up, the EGR cooler 118 has the maximum amount of exhaust flow it can handle, and transfers the maximum amount of heat from the exhaust into the coolant until the target coolant temperature is reached. This allows the waste heat recovery system to get the fullest possible utility out of the exhaust heat energy that would otherwise be wasted out of the tailpipe.

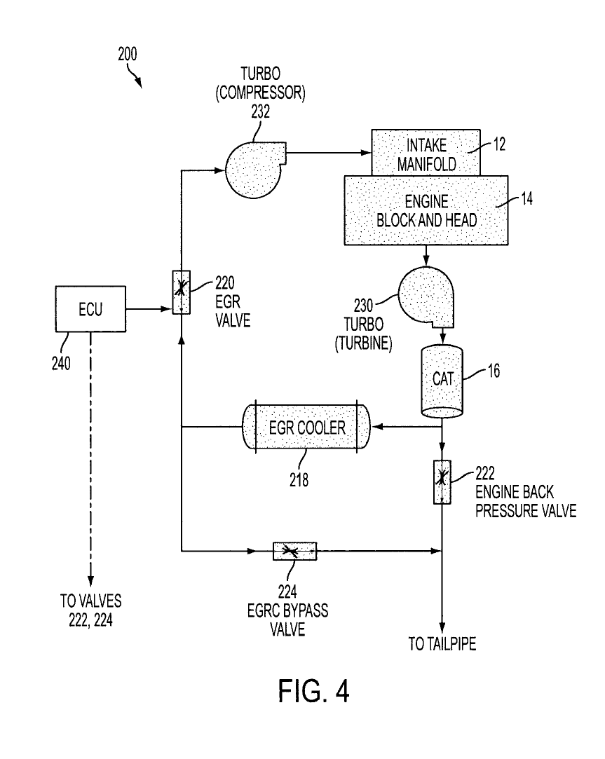

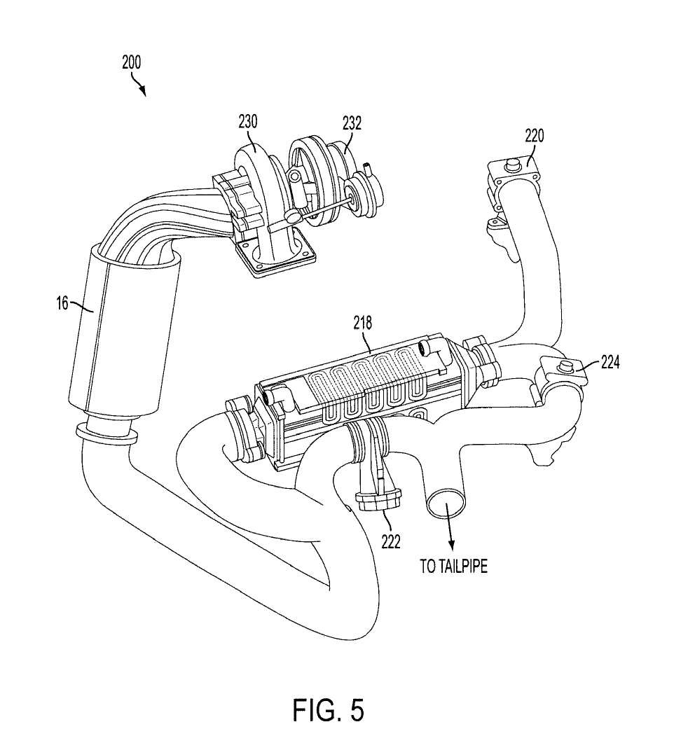

Referring to FIG. 4, an engine coolant heating system 200 in accordance with a second disclosed embodiment is now described. The system 200 achieves the same benefits and advantages as system 100. The system 200 includes an intake manifold 12, an engine block 14, a catalytic converter 16, an EGR cooler 218, EGR valve 220, engine back pressure valve (EBPV) 222 and an EGR bypass valve (EBV) 224. The engine back pressure valve 222 is connected between the exhaust piping to the tailpipe and a connection between the inlet of the cooler 218 and outlet of the catalytic converter 16. The EGR bypass valve 224 is connected between the exhaust piping to the tailpipe and a connection between the outlet of the cooler 218 and an inlet of the EGR valve 220. FIG. 5 shows the piping/tubing used to connect the components of system 200.

The system 200 is designed for use in a turbocharged vehicle. As such, the system 200 also includes a turbo compressor 232 connected between the EGR valve 220 and the intake manifold 12 and a turbo turbine 230 connected between the engine block 14 and the inlet of the catalytic converter 16. It should be appreciated that the recirculated exhaust gas will pass through the compressor 232 before entering the intake manifold 12. It also should be appreciated that engine exhaust will pass through the turbine 230 before entering the catalytic converter 16. Otherwise, the system 200 is operated in the same manner, with the same operating modes, as system 100 discussed above with respect to FIGS. 2 and 3. That is, an engine control unit 240 or other suitable controller controls the opening and closing of the valves 220, 222 and 224 in the manner discussed above with respect to FIGS. 2 and 3.

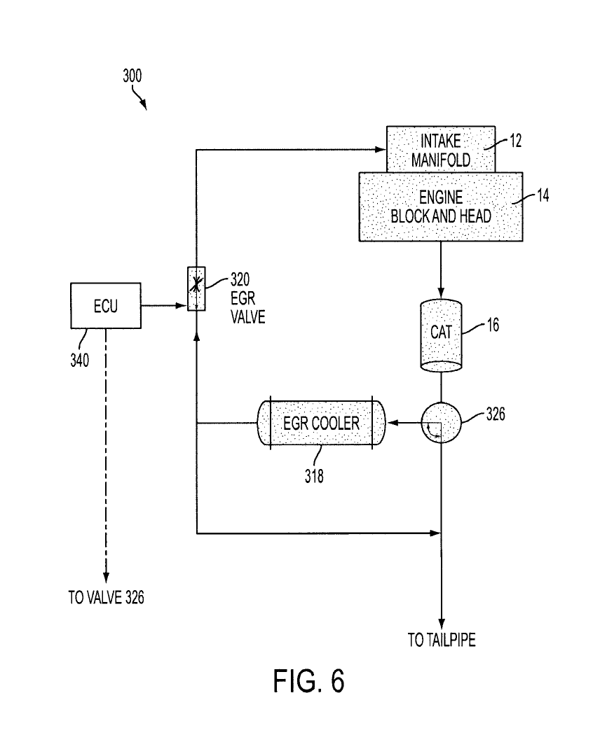

FIG. 6 illustrates an engine coolant heating system 300 in accordance with a third disclosed embodiment. The system 300 includes an intake manifold 12, an engine block 14, a catalytic converter 16, an EGR cooler 318 and an EGR valve 220. Unlike systems 100 and 200, system 300 includes a 3-way flapper style exhaust valve 326 Instead of an engine back pressure valve and an EGR bypass valve. The system 300 has an advantage over other embodiments in that by using the three-way valve 326, the system 300 has less components and is easier to control since it has less components that need to be controlled. The EGR valve 320 and the three-way valve 326 are controlled by an engine control unit 340 or other suitable controller to achieve the two operating modes discussed above with respect to FIGS. 2 and 3 using only the EGR valve 220 and three-way valve 326.

When the coolant is already at the optimal operating temperature and there is no need for coolant heating, the three-way valve 326 and the EGR valve 320 are set to allow approximately 40% of the exhaust flow to go through the EGR cooler 318 and then back to then engine 14 (via manifold 12) for re-combustion. The remaining exhaust gas simply continues down the main exhaust pipe and out of the vehicle. When there is a need to rapidly heat up the engine coolant, the three-way valve 326 is set to force 100% of the exhaust flow through the EGR cooler 318. Downstream of the EGR cooler 318, the position of the EGR valve 320 is set to allow up to approximately 40% of the flow to return to the intake manifold 12 while the remainder of the flow passes to the main exhaust pipe and out of the vehicle.

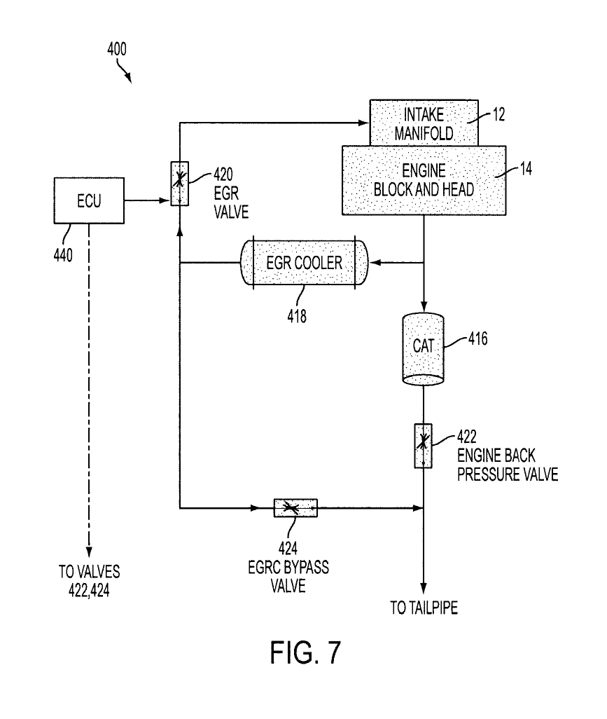

It should be appreciated that any of the systems 100, 200, 300 disclosed herein may be modified to move the catalytic converter 16 downstream of the respective EGR cooler 118, 218, 318. That is, the disclosed systems 100, 200, 300 are not to be limited by the location of the catalytic converter 16 shown in FIGS. 2-6. FIG. 7 illustrates one system 400 that is similar to the system 100 illustrated in FIG. 1 except for the location of the catalytic converter 416. The configuration of system 400 has the benefit of allowing the cooler 418 to be mounted closer to the exhaust manifold for maximum exhaust temperature and maximum exhaust heat recovery.

As shown in the illustrated embodiment, the system 400 also includes an intake manifold 12, an engine block 14, an EGR cooler 418, EGR valve 420, engine back pressure valve 422 and an EGRC bypass valve 424. In this embodiment, the catalytic converter 416 is located downstream of the input to the cooler 418. Moreover, the engine back pressure valve 422 is connected between the exhaust piping to the tailpipe and the outlet of the catalytic converter 416. The EGR bypass valve 424 is still connected between the exhaust piping to the tailpipe and a connection between the outlet of the cooler 418 and an inlet of the EGR valve 420. The opening and closing of the valves 420, 422 and 424 are controlled in the manner discussed above regarding FIGS. 2 and 3 by an engine control unit 440 or other suitable controller.

The disclosed coolant heating systems 100, 200, 300, 400 can be contrasted against typical exhaust waste heat recovery systems, and against typical cooled EGR systems. Typical exhaust waste heat recovery systems involve the use of a separate and dedicated exhaust-to-coolant heat exchanger that is installed directly into the main exhaust pipe. This configuration has many drawbacks. For a vehicle that already has an EGR cooler, this configuration requires a separate and un-related exhaust-to-coolant heater. This second heat exchanger adds unnecessary cost and weight to the vehicle.

In addition, since the separate exhaust-to-coolant heat exchanger is typically installed in the main exhaust pipe near the rear of the vehicle, coolant must be routed along almost the entire length of the vehicle. Even with insulated coolant lines, some of the heat added to the coolant by the exhaust is lost via convection across the long coolant lines. The long coolant lines also increase the pressure drop of the cooling circuit, increasing the load on the coolant pump. Moreover, the nature of a heat exchanger built directly into the main exhaust pipe prevents the use of extended surface area (i.e., fins) on the exhaust side of the heat exchanger. Since the thermal performance of an exhaust-to-coolant heat exchanger is extremely exhaust-side dependent, a heat exchanger without exhaust side fins has much lower thermal efficiency than one that has them

Typical cooled EGR systems utilize an EGR cooler that is sized to meet the cooling demands of the engine's peak power condition, where the exhaust temperatures and flows are highest. In reality, the vehicle spends a very small portion of its life at this peak power condition, which means that the EGR cooler is oversized for the most typical driving conditions. This lack of cooler utility results in wasted money (to buy the large cooler), wasted fuel (due to additional mass), and wasted packaging space—all of which is undesirable.

The disclosed systems 100, 200, 300, 400 have the following advantages over the typical exhaust waste heat recovery systems, and typical cooled EGR systems described above. First, the disclosed systems accomplish EGR cooling and rapid coolant heating within the same heat exchanger. This provides a lower cost and much better fuel economy than the typical exhaust waste heat recovery and cooled EGR systems, which include the separate and dedicated exhaust-to-coolant heat exchanger. Second, the entire coolant heating system 100, 200, 300 disclosed herein is installed directly behind the engine, with coolant hoses less than 1 meter long. This results in minimal convective heat losses in the coolant lines and minimal coolant pressure drop. Moreover, the coolant heater/EGR cooler disclosed herein has brazed fins on the exhaust side for efficiency (e.g., 90-95%).

The disclosed coolant heating systems 100, 200, 300, 400 also increase the utility of their EGR coolers by using it to rapidly warm-up the coolant at engine cold start. What would otherwise be wasted money, fuel, and packaging space is now used for quicker coolant warm-up and a resulting fuel economy improvement, which is extremely beneficial.

What is claimed is:

1. An engine coolant heating system for a vehicle, said system comprising:
an exhaust gas recirculation cooler having an input for receiving exhaust gas from an engine and an output for outputting cooled exhaust gas;
an exhaust gas recirculation valve connected between an input of an intake manifold and the output of the exhaust gas recirculation cooler; and
at least one additional valve connected at least between the input of the exhaust gas recirculation cooler, an output of the exhaust gas recirculation cooler and an exhaust output,
wherein said at least one additional valve is for configuring the system in a first configuration whereby a portion of the exhaust gas from the engine is passed through the cooler before a predetermined amount of cooled exhaust gas is passed through the exhaust gas recirculation valve to the intake manifold, and for configuring the system in a second configuration whereby substantially all of the exhaust gas from the engine is passed through the cooler before the predetermined amount of cooled exhaust gas is passed through the exhaust gas recirculation valve to the intake manifold.

2. The system of claim 1, wherein said at least one additional valve is a single multi-position valve having a first position corresponding to the first configuration and a second position corresponding to the second configuration.

3. The system of claim 1, wherein said at least one additional valve comprises:
a first valve connected between the input of the cooler and the exhaust output; and
a second valve connected between a connection of an output of the first valve and the exhaust output and a connection between the output of the cooler and an input of the exhaust gas recirculation valve.

4. The system of claim 3, wherein the first valve causes substantially all of the exhaust gas from the engine to be passed through the cooler in the second configuration.

5. The system of claim 3, wherein the second valve causes no cooled exhaust gas to pass to the exhaust output in the first configuration and a second predetermined portion of cooled exhaust gas to pass to the exhaust output in the second configuration.

6. The system of claim 1, further comprising a catalytic converter connected between an output of the engine and the input to the cooler.

7. The system of claim 1, further comprising a catalytic converter connected between the input to the cooler and the exhaust output.

8. The system of claim 1, further comprising a turbo compressor between an output of the exhaust gas recirculation valve and the input of the intake manifold.

9. The system of claim 8, further comprising a turbo turbine between an output of the engine and the input to the cooler.

10. The system of claim 1, wherein the predetermined amount of cooled exhaust gas is less than or equal to 40% of the cooled exhaust gas.

11. The system of claim 1, wherein the portion of the exhaust gas is less than or equal to 40% of the exhaust gas.

12. A method of recirculating exhaust gas output from an engine, said method comprising:
configuring an exhaust gas recirculation valve and at least one additional valve into a first configuration whereby a portion of exhaust gas output from the engine is passed through an exhaust gas recirculation cooler before a predetermined amount of cooled exhaust gas is passed through the exhaust gas recirculation valve to an intake manifold; and
configuring the exhaust gas recirculation valve and the at least one additional valve into a second configuration whereby substantially all of the exhaust gas output from the engine is passed through the cooler before the predetermined amount of cooled exhaust gas is passed through the exhaust gas recirculation valve to the intake manifold.

13. The method of claim 12, wherein the at least one additional valve is a single multi-position valve having a first position corresponding to the first configuration and a second position corresponding to the second configuration.

14. The method of claim 12, wherein the at least one additional valve comprises first and second valves and the first valve causes substantially all of the exhaust gas from the engine to be passed through the cooler in the second configuration.

15. The method of claim 12, wherein the at least one additional valve comprises first and second valves and the second valve causes no cooled exhaust gas to pass to the exhaust output in the first configuration and a second predetermined portion of cooled exhaust gas to pass to the exhaust output in the second configuration.

16. The method of claim 12, further comprising passing the exhaust gas output from the engine through a catalytic converter before passing the exhaust gas through the cooler.

17. The method of claim 12, further comprising passing the exhaust gas output from the engine through a catalytic converter before passing the exhaust gas through the exhaust output.

18. The method of claim 12, wherein the predetermined amount of cooled exhaust gas is less than or equal to 40% of the cooled exhaust gas.

19. The method of claim 12, wherein the portion of the exhaust gas is less than or equal to 40% of the exhaust gas.
